(19) United States
(12) Patent Application Publication
(10) Pub. No.: US 2013/0278118 A1
(43) Pub. Date: Oct. 24, 2013

(54) IMPULSE RING FOR A BEARING ASSEMBLY, BEARING ASSEMBLY COMPRISING SUCH AN IMPULSE RING AND ROTARY ELECTRICAL MACHINE COMPRISING SUCH A BEARING ASSEMBLY

(71) Applicants: Pierrick Maze, Tours (FR); Sylvain Chaussat, Tours (FR)

(72) Inventors: Pierrick Maze, Tours (FR); Sylvain Chaussat, Tours (FR)

(21) Appl. No.: 13/880,106

(22) PCT Filed: Oct. 18, 2010
(86) PCT No.: PCT/IB10/03025

§ 371 Date: Jun. 27, 2013

(51) Int. Cl. H02K 11/00; G01B 7/30

(52) U.S. Cl. CPC H02K 11/0021; G01B 7/30
USPC 310/68 B; 324/207.25

(57) ABSTRACT

This impulse ring (2) for a bearing assembly comprising a rotative element on which the impulse ring (2) is mounted, is rotatable with respect to a fixed sensing element adapted to detect a magnetic field generated by the impulse ring (2). The impulse ring (2) comprises at least one pair of magnetic poles (N, S) or at least one magnet (4) with north poles (N) and south poles (S) alternatively arranged along its circumference. The intensity of the magnetic field generated by the north poles (N) is different from the intensity of the magnetic field generated by the south poles (S).

### TECHNICAL FIELD OF THE INVENTION

The invention concerns an impulse ring for a bearing assembly. The invention also concerns a bearing assembly comprising such an impulse ring. The invention further concerns a rotary electrical machine equipped with such a bearing assembly.

### BACKGROUND OF THE INVENTION

Bearing assemblies equipped with sensing elements adapted to read impulse rings, in order to determine angular positions or rotation speeds, often operate in areas where disturbing magnetic fields are present. In case a sensing element is adapted to detect the variations of the intensity of the magnetic field generated by the impulse ring, a disturbing magnetic field, which can be generated, for example, by a rotary electrical machine or another equipment, can induce accuracy issues.

Impulse rings are generally dimensioned so as to obtain a duty cycle of 50%, which means that the positive magnetic field generated by the south poles is compensated by the negative magnetic field generated by the north poles. A duty cycle of 50% allows a greater accuracy in the data delivered by the sensor.

A disturbing magnetic field, which can be positive or negative, induces an imbalance, which causes the duty cycle of the magnetic field detected by the sensing element to be different from 50%. In order to keep an optimal accuracy of the sensing, it is therefore requested to compensate for the disturbing magnetic field.

To compensate for disturbing magnetic fields, known techniques use detecting cells with offset. These techniques are not satisfying, because cells with offset are not as accurate as cells without offset, and because the offset cannot be controlled without using programmable ones.

### SUMMARY OF THE INVENTION

This invention aims at proposing a new impulse ring for a bearing assembly, which permits to compensate for a disturbing magnetic field, without reducing the accuracy of the measurement of the intensity of the magnetic field generated by the impulse ring, and whose compensating ability is adapted to the intensity of the disturbing magnetic field.

To this end, the invention concerns an impulse ring for a bearing assembly comprising a rotative element on which the impulse ring is mounted, rotatable with respect to a fixed sensing element adapted to detect a magnetic field generated by the impulse ring, the impulse ring comprising at least one pair of magnetic poles or at least one magnet with north poles and south poles alternatively arranged around the circumference of the impulse ring. This impulse ring is characterized in that the intensity of the magnetic field generated by the north poles is different from the intensity of the magnetic field generated by the south poles.

Thanks to the invention, a disturbing magnetic field can be compensated by unbalancing the respective magnetic fields generated by north poles and south poles of the impulse ring. This permits to obtain a duty cycle of 50% in a magnetically disturbed environment and therefore to obtain an accurate measurement.

According to further aspects of the invention which are advantageous but not compulsory, such an impulse ring may incorporate one or several of the following features:
All the north poles have the same volume, whereas all the south poles have the same volume, and whereas the north poles and the south poles have different volumes.
The north poles and south poles cover angular sectors having different apex angles.
The north poles and south poles have different thicknesses with respect to a radial direction of the impulse ring.
The north poles and the south poles have different widths, with respect to a direction parallel to the rotation axis of the impulse ring.
The north poles and the south poles are realized in different materials.
The magnetic properties of the materials in which the north poles and the south poles are realized are altered.
The north poles and south poles are covered with absorber varnish layers of different respective thicknesses and/or different respective magnetic properties.
The impulse ring comprises a magnetic frame comprising casings in which the magnetic poles or the magnets are arranged and whereas the casings have different influences on the magnetic fields generated by the north poles and south poles.
The impulse ring comprises an amagnetic frame comprising casings in which the magnetic poles or the magnets are arranged.
South poles or north poles are mounted in open casings.

The invention also concerns a bearing assembly comprising a rotatable ring, a non-rotatable ring and an above-mentioned impulse ring. Alternatively, the bearing assembly further comprises as sensor adapted to read the impulse ring.

The invention also concerns a rotary electrical machine such as a motor and/or a generator, self-generating or being immersed, in operation, in a disturbing magnetic field, and comprising a stator and a rotor. This rotary electrical machine is characterized in that it comprises an above mentioned bearing assembly and a sensor for reading the impulse ring, in that the bearing assembly supports the rotor with respect to the stator and in that the sensor delivers a signal for controlling the rotation of the rotor.

Alternatively, the invention concerns a rotary electrical machine such as a motor and/or a generator, self-generating or being immersed, in operation, in a disturbing magnetic field, and comprising a stator and a rotor. This rotary electrical machine is characterized in that it comprises an above mentioned bearing assembly which supports the rotor with respect to the stator, and in that the sensor delivers a signal for controlling the rotation of the rotor.

### BRIEF DESCRIPTION OF THE DRAWINGS

The invention will now be explained in correspondence with the annexed figures and as an illustrative example, without restricting the object of the invention. In the annexed figures:

FIG. 1 is a partial sectional view of a bearing assembly and a rotary electrical machine according to the invention;

FIG. 2 is an axial view of an impulse ring belonging to the assembly of FIG. 1 and according to a first embodiment of the invention;

FIG. 3 is a magnetic field intensity versus angular position chart representing the variations of the magnetic field generated by a classical impulse ring operating in a normal environment, by a classical impulse ring operating in a disturbing magnetic field, and by the impulse ring of FIG. 2;

FIG. 4 is an axial view similar to FIG. 2 of an impulse ring according to a second embodiment of the invention.

### DETAILED DESCRIPTION OF SOME EMBODIMENTS

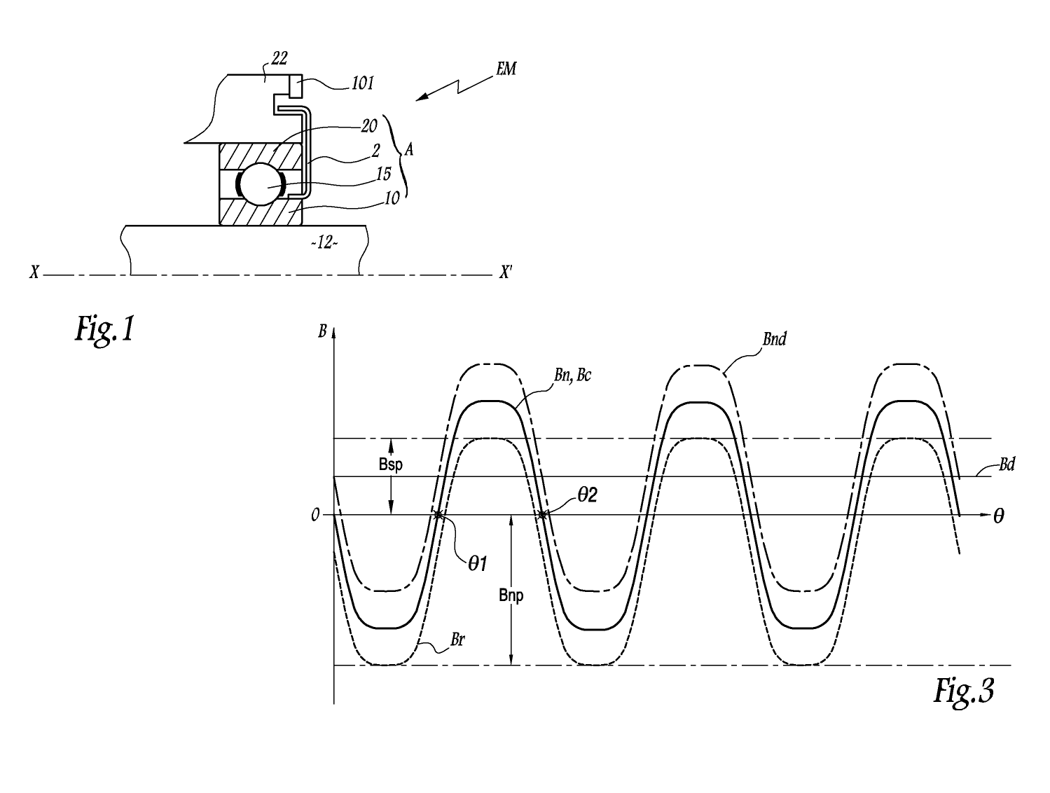

FIG. 1 represents a bearing assembly A, which comprises an inner ring 10, an outer ring 20 and rolling balls 15. Inner ring 10 is rotatable, around a rotation axis X-X′, with respect to a non-rotatable outer ring 20.

Outer ring 20 is fixed to a stator 22 belonging to a rotary electrical machine EM. Inner ring 10 is fixed to a rotor 12 belonging to rotary electrical machine EM and rotatable with respect to stator 22 around axis X-X′. Rotary electrical machine EM can be a motor and/or a generator, such as a starter-alternator of an automotive vehicle.

As represented on FIG. 1, a sensor or sensing element 101 of electrical machine EM detects the variations of the intensity of an ambient magnetic field B in the vicinity of this sensing element. Sensing element 101 is fixed to stator 22, which is fast in rotation with non-rotatable ring 20, and adapted to detect the variations of the intensity of a magnetic field Br generated by an impulse ring 2, which is fixed to inner ring 10. Sensor or sensing element 101 is adapted to deliver a signal for controlling the rotation of rotor 22.

Impulse ring 2 comprises eight pairs of magnetic poles, for instance arranged in adjacent magnets comprising north poles N and south poles S alternatively arranged around the circumference of impulse ring 2. The rotation of impulse ring 2 induces variations of the intensity of magnetic field Br in front of sensing element 101. The variations of magnetic field Br have a sinusoidal waveform with a periodicity corresponding to one electrical rotation of impulse ring 2. An electrical rotation is done when a north pole N and a south pole S of a magnet 4 revolve in front of sensing element 101.

On FIG. 3, θ denotes the electrical angular position of impulse ring 2.

In general, impulse rings are adapted to generate magnetic fields having a duty cycle of 50%, in order to provide an accurate measurement. To obtain a duty cycle equal to 50%, the intensity of the magnetic field Bnp generated by north poles must be equal to the intensity of the magnetic field Bsp generated by south poles S. Such an impulse ring induces a balanced magnetic field Bn, which is symmetrical with respect to the horizontal axis on FIG. 3.

In case sensing element 101 is in an area in which a disturbing magnetic field Bd exists, magnetic field Bnd detected by sensing element 101 equals the normal magnetic field Bn added to the disturbing magnetic field Bd. This detected magnetic field Bnd is not symmetrical with respect to the horizontal axis of FIG. 3. On FIG. 3, disturbing magnetic field Bd is constant for the understanding of the figures. This is a simple case, and disturbing fields Bd can have a varying intensity and be provoked by different sources. Disturbing field Bd can be generated by rotary electrical machine EM itself.

Magnetic field Bnd does not have a duty cycle of 50%, because it has a positive portion which is strictly superior or inferior to its negative portion.

In order to obtain a duty cycle of 50% in an area disturbed by an exterior magnetic field, impulse ring 2 is adapted to generate a magnetic field whose duty cycle is different from 50% and which permits to compensate disturbing magnetic field Bd. In order to generate this unbalanced magnetic field Br, north poles N of impulse ring 2 are adapted to generate a magnetic field Bnp of a different intensity with respect to the magnetic field Bsp generated by south poles S. This intensity difference can be set by determining a magnetic field intensity ratio R. Ratio R is determined on the basis of a measurement of the intensity of disturbing magnetic field Bd. This can be done thanks to a magnetic sensor or by any equivalent mean.

In case the waveform of magnetic field Br is a “perfect” sinusoidal curve, the respective dimensions of north poles N and south poles S can be determined in order to obtain eventually a duty cycle of 50% as seen by the sensor 101. With a constant disturbing magnetic field Bd, the intensity of ambient magnetic field B can be written as follows:

B(θ)=Br sin(θ)+Bd (1)

The electrical angular position at which B equals 0 can be determined on the basis of equation (2) written as follows:

$$B ( θ ) = 0 ⇔ sin θ = \frac{Bd}{Br} \qquad ( 2 )$$

This equation has two solutions, namely

$$\begin{matrix}θ 1 = Arc sin ( - \frac{Bd}{Br} ) & ( 3 ) \\ θ 2 = Π - Arc sin ( - \frac{Bd}{Br} ) & ( 4 )\end{matrix}$$

θ1 and θ2 denote the electric angular positions at which magnetic field B equals 0, and crosses the horizontal axis on FIG. 3.

Duty cycle DC can be obtained by the following relation, which permits to determine the ratio between the positive and negative portions of magnetic field B:

$$D C = \frac{θ 2 - θ 1}{2 Π} \qquad ( 5 )$$

By injecting relations (3) and (4) into relation (5), one can determine the expression of duty cycle DC, as follows:

$$D C = \frac{Π - 2 Arc sin ( - \frac{Bd}{Br} )}{2 Π} \qquad ( 6 )$$

Thanks to relation (6), one can determine magnetic field Br generated by impulse ring 2 so as to obtain a duty cycle DC of 50%. To obtain the adequate magnetic field Br, a first embodiment of the invention consists in realizing north poles N which have a different volume with respect to south poles S, all the north poles having respectively the same volumes, whereas all the south poles have the same volume.

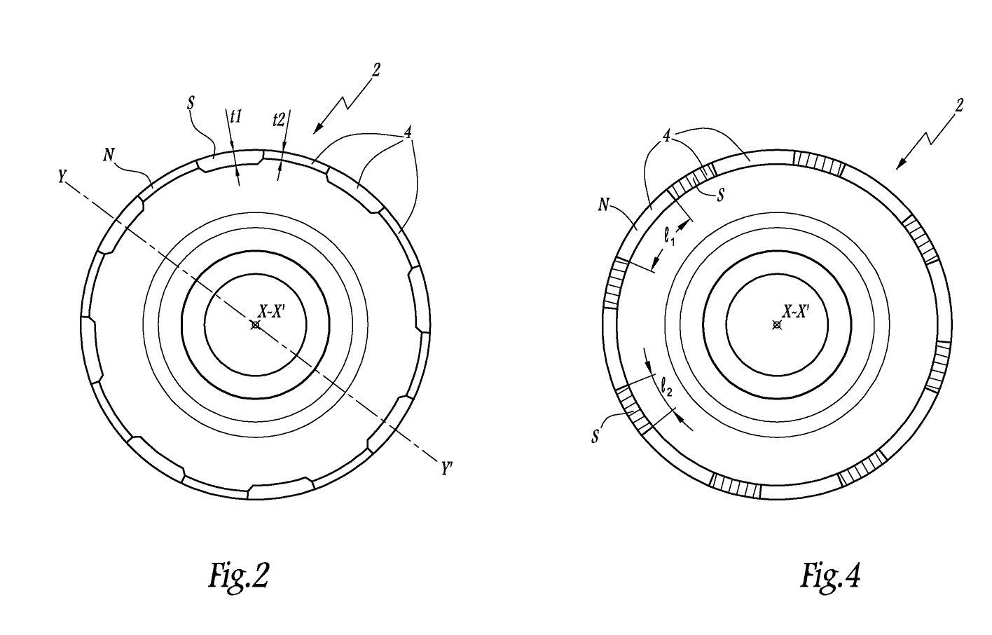

These different volumes are obtained for instance by using different poles thicknesses, as represented on FIG. 2. In this example, disturbing magnetic field Bd is a constant positive field. This implies that impulse ring 2 must be unbalanced to obtain a magnetic field which has a more important negative portion. To this end, north poles are dimensioned so as to generate a magnetic intensity higher than the intensity generated by south poles. On FIG. 2, north poles have a thickness t1, along a radial axis Y-Y′ perpendicular to axis X-X′, superior to the thickness t2 of south poles S. Thicknesses t1 and t2 are determined on the basis of a measurement of disturbing field Bd, and on the basis of a theoretical relation with which one can determine magnetic field Br.

According to another embodiment represented on FIG. 4, the different volumes, and therefore the resulting magnetic imbalance of impulse ring 2, are obtained by using north poles N which cover angular sectors having an apex angle I1 superior to the apex angle I2 of the angular sectors covered by the south poles, with respect to axis X-X′. The ratio between I1 and I2 is determined on the basis of a measurement of the intensity of disturbing magnetic field Bd and a theoretical relation relating the angular sectors covered by north and south poles and magnetic field Br generated by impulse ring 2.

According to another embodiment which is not represented on the figures, north poles N and south poles S may have different widths along a direction parallel to axis X-X′, with a ratio determined on the same basis as in the previous embodiments.

According to alternate embodiments, the different intensities of the magnetic fields Bnp and Bsp generated by north poles N and south poles S may be obtained by realizing north poles N and south poles S with different materials, having different magnetic properties. For example, in order to compensate positive disturbing field Bd, north poles N may be realized in a rare earth material such as Neodymium or Sabarium-Cobalt, and south poles may be realized in plasto-ferrite, that-is-to-say ferrite powder embedded in a thermoplastic matrix.

According to an alternate embodiment, north poles and south poles may be realized in materials whose magnetic properties have been altered in order to obtain the adequate magnetic field intensity ratio.

According to a non-shown embodiment, north poles N and south poles S may be covered by material layers such as absorber varnish. Different layer thicknesses can be used in order to obtain the adequate intensity ratio. North poles and south poles can also be respectively covered with materials of different magnetic properties, for instance different magnetic permeabilities.

According to a non shown embodiment, impulse ring 2 comprises a frame made from a magnetic material, such as the AISI 1008 steel. The frame comprises casings in which pairs of magnetic poles or magnets 4 are arranged. In the case magnets are used, magnets 4 are glued onto the frame. The frame can also be partly crimped around magnets 4. To obtain the adequate intensity ratio R to compensate disturbing field Bd, the casings can be made so as to deviate or absorb a different proportion of the intensities of the magnetic fields Bnp and Bsp generated by north poles N and south poles S., North poles N and south poles S may also be mounted in casings of different materials with different magnetic permeability and/or different thicknesses. For instance, the thickness of the casings hosting the north poles N can be different from the thickness of the casings hosting the south poles S.

In another not illustrated embodiment, the frame may comprise casings made from an amagnetic material such as the AISI 316 stainless steel, and casings made from a magnetic material such as the AISI 1008 steel.

In another embodiment not illustrated, the frame may be entirely made from an amagnetic material. In such a case, the adequate intensity ratio R is set by making north poles N and south poles S of different volumes as previously explained.

North poles or south poles may also be mounted in open casings in order to reduce the absorption of the magnetic fields so as to obtain the adequate intensity ratio R.

As represented on FIG. 3, magnetic field Br generated by impulse ring 2 is lower than magnetic field Bn generated by a classical impulse ring. The corrected magnetic field Bc detected by the sensing element, which equals magnetic field Br added to disturbing magnetic field Bd is symmetrical with respect to the horizontal axis on FIG. 3 and is superimposed to normal magnetic field Bn.

In order to compensate a disturbing magnetic field Bd of high intensity, the technical features of the various embodiments of the invention can be combined. For example, different north poles and south poles thicknesses and, more generally, different dimensions can be combined to different layers of absorbing materials and to different frame structures.

The invention can be used to compensate disturbing magnetic fields of different polarities and directions, and non constant disturbing magnetic fields. The invention can also be used in the case of non-sinusoidal magnetic field intensity waveforms.

The invention can be used with a rolling bearing, e.g a ball bearing, a needle bearing or a roller bearing. It can also be used with a plain bearing.

According to another non-shown embodiment, sensing element 101 can be integrated in bearing assembly A and particularly mounted on outer non-rotatable ring 20.

1. An impulse ring (2) for a bearing assembly comprising:
a rotative element on which the impulse ring is mounted, rotatable with respect to a fixed sensing element adapted to detect a magnetic field (Br) generated by the impulse ring, the impulse ring having at least one pair of magnetic poles (N, S) or at least one magnet with north poles (N) and south poles (S) alternatively arranged along the circumference of the impulse ring, wherein
the intensity of the magnetic field (Bnp) generated by the north poles (N) is different from the intensity of the magnetic field (Bsp) generated by the south poles (S).

2. The impulse ring according to claim 1, wherein all the north poles (N) have the same volume, wherein all the south poles (S) have the same volume, and wherein the north poles (N) and the south poles (S) have different volumes.

3. The impulse ring according to claim 1, wherein the north poles (N) and south poles (S) cover angular sectors having different apex angles.

4. The impulse ring according to claim 1, wherein the north poles (N) and south poles (S) have different thicknesses (t1, t2) with respect to a radial direction (Y-Y′) of the impulse ring (2).

5. The impulse ring according to claim 1, wherein the north poles (N) and the south poles (S) have different widths, with respect to a direction parallel to the rotation axis (X-X′) of the impulse ring.

6. The impulse ring according to claim 1, wherein the north poles (N) and the south poles (S) are realized in different materials.

7. The impulse ring according to claim 1, wherein the magnetic properties of the materials in which the north poles (N) and the south poles (S) are realized are altered.

8. The impulse ring according to claim 1, wherein the north poles (N) and south poles (S) are covered with absorber varnish layers of different respective thicknesses and/or different respective magnetic properties.

9. The impulse ring according to claim 1, further comprising a magnetic frame having casings in which the pairs of poles (N, S) or the magnets are arranged, and wherein the casings have different influences on the magnetic fields (Bnp, Bsp) generated by the north poles (N) and south poles (S).

10. The impulse ring according to claim 1, further comprising an amagnetic frame comprising casings in which the pairs of poles (N, S) or the magnets are arranged.

11. The impulse ring according to claim 9, wherein south poles (S) or north poles (N) are arranged in open casings.

12. A bearing assembly (A) comprising:
a rotatable ring,
a non-rotatable ring and
an impulse ring having:
a rotative element on which the impulse ring is mounted, rotatable with respect to a fixed sensing element adapted to detect a magnetic field (Br) generated by the impulse ring, the impulse ring having at least one pair of magnetic poles (N, S) or at least one magnet with north poles (N) and south poles (S) alternatively arranged along the circumference of the impulse ring, wherein
the intensity of the magnetic field (Bnp) generated by the north poles (N) is different from the intensity of the magnetic field (Bsp) generated by the south poles (S).

13. The bearing assembly according to claim 12, further comprising a sensor adapted to read the impulse ring.

14. The bearing assembly according to claim 13, wherein the sensor is mounted on the non-rotatable ring or on a part rotatably fastened with the non-rotatable ring.

15. A rotary electrical machine (EM) such as a motor and/or a generator, self-generating or being immersed, in operation, in a disturbing magnetic field (Bd), and comprising:
a stator (22),
a rotor (12),
a bearing assembly (A) having a rotatable ring,
a non-rotatable ring and
an impulse ring having;
a rotative element on which the impulse ring is mounted, rotatable with respect to a fixed sensing element adapted to detect a magnetic field (Br) generated by the impulse ring, the impulse ring having at least one pair of magnetic poles (N, S) or at least one magnet with north poles (N) and south poles (S) alternatively arranged along the circumference of the impulse ring, wherein
the intensity of the magnetic field (Bnp) generated by the north poles (N) is different from the intensity of the magnetic field (Bsp) generated by the south poles (S), and
a sensor for reading the impulse ring, wherein
the bearing assembly (A) supports the rotor with respect to the stator and wherein the sensor delivers a signal for controlling the rotation of the rotor.

16. A rotary electrical machine (EM) such as a motor and/or a generator, self-generating or being immersed, in operation, in a disturbing magnetic field (Bd), and comprising:
a stator (22),
a rotor (12), and
a bearing assembly (A) having a sensor adapted to read the impulse ring, wherein
the bearing assembly (A) supports the rotor with respect to the stator and wherein the sensor delivers a signal for controlling the rotation of the rotor.
